(19) United States
(12) Patent Application Publication
(10) Pub. No.: US 2026/0106939 A1
(43) Pub. Date: Apr. 16, 2026

(54) NETWORK AWARE DO NOT DISTURB MODE

(71) Applicant: T-Mobile Innovations LLC, Overland Park, KS (US)

(72) Inventors: Jagannadha Anudeep Varma DATLA, Kent, WA (US); Harikishore ALLU BALAN, Lynnwood, WA (US)

(21) Appl. No.: 18/917,406

(22) Filed: Oct. 16, 2024

(51) Int. Cl. H04M 3/54; H04M 3/533; H04M 3/436

(52) U.S. Cl. CPC H04M 3/543; H04M 3/533; H04M 3/436

(57) ABSTRACT

Methods and systems provided herein provide for providing a network aware do not disturb (DND) system. The network aware DND system registers for multimedia telephony (MMTEL) settings of a wireless device that include a DND allowed list. The network aware DND system proceeds to route incoming calls for the wireless device based on the MMTEL settings and the DND allowed list.

### TECHNICAL BACKGROUND

As wireless networks evolve and grow, there are ongoing challenges in communicating data across different types of networks. For example, a wireless network may include one or more access nodes, such as base stations, including, for example evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes. Newer networks introduce new features as well as new challenges.

Currently, when a wireless device or user equipment (UE) user configures do not disturb (DND) mode for the wireless device, incoming calls terminating at the wireless device reach the wireless device and are rejected based on the local DND configuration. This implementation of DND mode creates excess network traffic as it is unnecessary for the wireless device to actually receive calls that a pre-configured setting on the wireless device rejects. However, in current implementations, the network is unaware of the DND mode configured at the wireless device and therefore continues to direct calls to the wireless device.

### OVERVIEW

Exemplary embodiments provided herein include a method for providing a network aware do not disturb (DND) mode for a wireless device. The method includes subscribing from a network node to user multimedia telephony (MMTEL) settings for a wireless device within a network. The MMTEL settings include a do not disturb (DND) allowed list. The method further includes storing the MMTEL settings including the DND allowed list on the network. Finally, the method includes receiving calls made to the wireless device at the network node and routing the calls made to the wireless device from the network node to either the wireless device or a voicemail server based on the stored MMTEL settings on the network.

In further embodiments, a network DND system is provided. The system includes a memory storing data and instructions and a processor within a network node executing the stored instructions to perform operations. The operations include subscribing to user multimedia telephony (MMTEL) settings for a wireless device within a network, wherein the MMTEL settings include a do not disturb (DND) allowed list. The operations include storing the MMTEL settings including the DND allowed list on the network. The operations additionally include routing calls from the network node in accordance with the MMTEL settings.

In a further embodiment, a non-transitory computer-readable medium stores instructions executed by a processor to perform multiple operations. The operations include subscribing to user multimedia telephony (MMTEL) settings for a wireless device within a network, wherein the MMTEL settings include a do not disturb (DND) allowed list. The operations additionally include storing the MMTEL settings including the DND allowed list on the network. The operations further include identifying a caller originating a call to the wireless device, determining the caller is not on the DND allowed list, and triggering direction of the call to a voicemail server.

Further embodiments include TASs and processing nodes performing the operations described above.

### BRIEF DESCRIPTION OF THE DRAWINGS

FIG. 1 depicts an exemplary environment for a network aware do not disturb (DND) system in accordance with an embodiment.

FIG. 2 depicts a network aware DND system in accordance with an embodiment.

FIG. 3 depicts a method for operating a network aware DND system in accordance with an embodiment.

FIG. 4 depicts a further exemplary method for operating a network aware DND system in accordance with an embodiment.

FIG. 5 depicts a further exemplary method for operating a network aware DND system in accordance with an embodiment.

FIG. 6 depicts an exemplary flow for subscribing to and operating a network DND system in accordance with an embodiment.

FIG. 7 depicts an additional exemplary method for routing of calls by a network aware DND system in accordance with an embodiment.

### DETAILED DESCRIPTION

In embodiments disclosed herein, a network aware do not disturb (DND) system is provided in a network in order to reduce unnecessary traffic towards a wireless device in DND mode. The network aware DND system may operate in combination with an internet protocol (IP) multimedia subsystem (IMS) containing a telephony application server (TAS) and may be incorporated therein or may function as a separate processing node in combination with the IMS and TAS.

In scenarios described herein, calls are routed based on multimedia telephony (MMTEL) settings. The settings are initiated at the wireless device by a wireless device user and captured and stored by the by the network aware DND system. In embodiments described herein, the network aware DND system includes a DND allowed list storing a list of allowed callers. Calls made to the wireless device may be screened by the network aware DND system to determine if a caller is on the DND allowed list prior to routing of the call to the wireless device. The call may be routed to the wireless device if the caller is on the DND allowed list, but may alternatively be routed to a voicemail server when the caller is not on the DND allowed list. Further, calls routed to the voicemail server may be logged such that call log updates may be maintained and silently pushed to the wireless device when the wireless device does not receive the calls due to the MMTEL settings.

In order to implement embodiments described herein, the MMTEL user profile currently maintained at the wireless device will additionally include an MMTEL DND allowed list as a DND feature tag. The DND allowed list may include the numbers or mobile station international subscriber directory numbers (MSISDNs) of allowed callers, who are entitled to reach the wireless device during DND mode. For example, the DND allowed list may include emergency contacts and close friends or relatives. The DND allowed list may be configured such that the user of the wireless device is able to update the DND allowed list, such as by adding or deleting contacts, for example through a native phone supplementary setting.

The network aware DND system may interact with the TAS to trigger the TAS to register for the MMTEL profile. The registration allows the wireless devices to communicate the MMTEL profile including the DND allowed list with the TAS. The registration may further cause the wireless device to send updates to the TAS when the updates are required. Additionally, the network aware DND system may trigger the TAS to save the DND allowed list, for example, in a TAS cache. Alternatively or additionally, the network aware DND system may cause the MMTEL profile to be saved in a home subscriber server (HSS). Additionally, the network aware DND system will cause the TAS to subscribe to the MMTEL profile, such that the TAS will automatically receive updates and modifications. For example, if a wireless device user deletes or adds entries from the DND allowed list, the TAS will automatically receive this update. Accordingly, when the user enables DND mode on the wireless device, the wireless device may send a session initiation protocol (SIP) update with MMTEL information towards the TAS.

Once the network is registered for DND features and the wireless device is set in DND mode, the network aware DND system ensures that the TAS routes all calls directed to the wireless device based on the MMTEL profile. Thus, for all mobile terminating (MT) calls to the wireless device, the TAS will route the call based on the MMTEL profile towards the terminating wireless device or a voice mail server that handles call for the wireless device. The calls originated by the users in the allowed list will be routed to the MT wireless device. When the originating user is not on the allowed list, the network aware DND system ensures that the TAS diverts the calls to a voicemail server. For diverted calls, the network aware DND system may trigger the TAS to send a SIP update with the caller details towards the wireless device to update the call log stored by the wireless device. Embodiments provided herein enable the determination of whether the user is busy to be done by the network instead of the wireless device. This adaptation reduces traffic and save processing time.

Accordingly, when DND is active on a wireless device, if the originating caller is not on the DND allowed list, the calls may be diverted as a result of user settings imported to the network from the wireless device. In this scenario, the call is missed and also diverted and it is possible for the network aware DND system to trigger maintenance of a call log within the network. Thus, in embodiments disclosed herein, wireless devices are able to receive updates including missed and diverted calls. The updates may provide the diversion reason of the diverted call in a call log pushed to the wireless device. The diversion reasons may include, for example, DND settings when callers are not on the DND allowed list or no reply from the wireless device in the instance where the originating caller was on the allowed list, but rejected the incoming call. Further, the network aware DND system may record a time stamp along with the missed call and the diversion reason.

After recording and maintaining the missed call log, the network aware DND system may trigger a session initiation protocol (SIP) notification towards the wireless device. The network aware DND system may automatically trigger the TAS to push the update for any missed call log in a SIP update towards the wireless device in a manner enabling the wireless device to decode the SIP update and display the missed calls and diversion reason along with the timestamps on the recent call log.

In addition to the systems and methods described herein, non-transitory computer-readable mediums may store the operations or the instructions for performing various methods. Further, processing nodes on the network may execute the instructions or methods. The processing node may include a processor included in TAS and/or a processor included in any controller node in the wireless network.

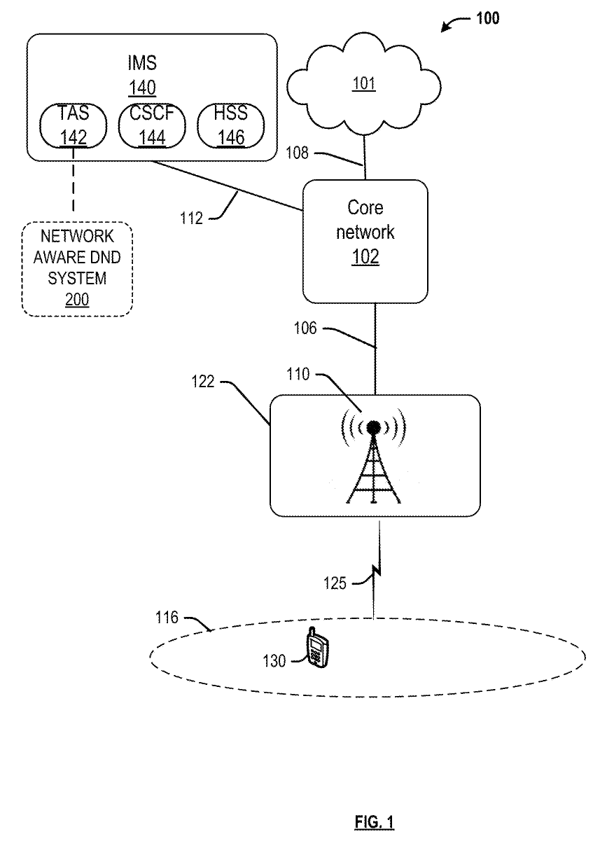

FIG. 1 depicts an exemplary environment 100 for implementing a network aware DND system 200. Environment 100 comprises a communication network 101, core network 102, a radio access network (RAN) 122 including at least an access node 110, and internet protocol (IP) multimedia subsystem (IMS) 140. Wireless device 130 is located in a coverage area 116 and communicates with the access node 110 over communication link 125. Although only one wireless device 130 is shown, it should be understood that any number of wireless devices could be included. Further, the network aware DND system 200 is included in or interacts with the IMS 140.

The IMS 140 is an architectural framework for delivering multimedia communications services such as voice, video and text messaging over IP networks. The IMS 140 may include multiple functions and nodes. For example the IMS 140 may include a telephony application server (TAS) 142, a call session control function (CSCF) 144, and a home subscriber server (HSS) 146. The TAS 142 is a back to back SIP user agent that maintains a call state. The TAS 142 contains service logic that provides basic call-processing services, such as, for example, digit analysis, routing, call setup, call waiting, call forwarding, etc. The CSCF 144 in the IMS 140 performs multiple roles and is implemented via servers using the SIP protocol to communicate. The HSS 146 functions as a master user database that supports IMS network entities that handle calls and sessions.

The core network 102 may include an SBA architecture, in which service-based interfaces may be utilized between control plane functions, while multiple user plane functions connect over point-to-point link. Multiple network functions within the core network 102 may communicate with and subscribe to multiple other network functions. For example, a network repository function (NRF) may maintain a record of available NFs and their supported services and allow NFs to subscribe and be notified of other NFs.

The network aware DND system 200 is illustrated as communicating with or incorporated in the IMS 140. In some embodiments, the network aware DND system 200 may be incorporated in or in direct communication with the TAS 142. The network aware DND system 200 may further communicate with or be partially incorporated in the CSCF 144 or the HSS 146. For example, the network aware DND system 200 may store call logs and/or MMTEL profiles with allowed lists at the HSS 146.

The RAN 122 can include various access network functions and devices disposed between the core network 102 and the end-user wireless device 130. For example, the RAN 122 includes at least an access node (or base station), such as an eNodeB and/or a next generation NodeB (gNodeB) 110 communicating with the end-user wireless device 130. Further, either of core network 102 and radio access network 122 can include one or more of a local area network, a wide area network, and an internetwork (including the Internet) and be capable of communicating signals and carrying data, for example, to support voice, push-to-talk, broadcast video, and data communications by end-user wireless device 130.

Access node 110 can be any network node configured to provide communication between end-user wireless device 130 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 130 are illustrated in FIG. 1, any number of access nodes and wireless devices can be implemented within environment 100.

Access node 110 can utilize antennas to deploy a wireless air interface 125 using one or more frequency bands over one or more coverage areas 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless device 130 may be any device, system, combination of devices, or other such communication platform capable of communicating wirelessly with access node 110 using one or more frequency bands deployed therefrom. Wireless device 130 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. The wireless device 130 can be end-user wireless devices (e.g., user equipment (UEs)) utilizing communication links 125, which may operate based on 6G, 5G new radio (NR), 4G long term evolution (LTE), or any other suitable type of ratio access technology (RAT).

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 130. Wireless network protocols can comprise multimedia broadcast multicast services (MBMS), code division multiple access (CDMA) single-Carrier radio transmission technology(1xRTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), Fifth Generation mobile networks or wireless systems (5G, 5G New Radio (“5G NR”), or 5G LTE), and/or other protocols. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or other protocols. Communication network 101 can also comprise additional base stations, controller nodes, telephony switches, internet routers, network gateways, computer systems, communication links, or some other type of communication equipment, and combinations thereof.

Communication links 106, 108, and 112 can use various communication media, such as air, space, metal, optical fiber, or some other signal propagation path - including combinations thereof. Communication links 106, 108, and 112 can be wired or wireless and use various communication protocols such as Internet, Internet protocol (IP), local-area network (LAN), optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol as described herein. Communication links 106, 108, and 112 can be a direct link or might include various equipment, intermediate components, systems, and networks. Communication links 106, 108, and 112 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, network functions, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

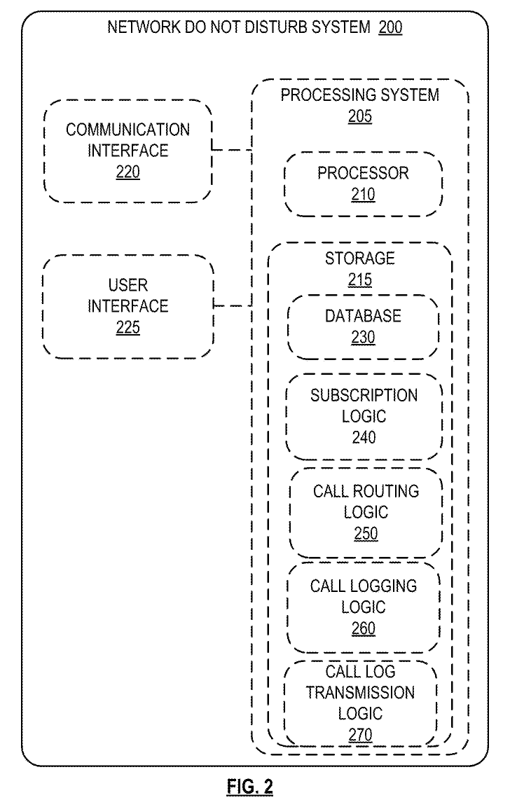

FIG. 2 illustrates a network aware DND system 200 in accordance with embodiments described herein. The components described herein are merely exemplary as many different configurations for the network aware DND system 200 may be implemented. The network aware DND system 200 may be configured to perform the methods and operations disclosed herein to trigger registration of network components to receive an MMTEL profile including an allowed list from a wireless device 130. The network aware DND system 200 may further be configured to receive updates to the MMTEL profile and may be aware of when wireless devices activate DND mode. The network aware DND system 200 may further cause maintenance of a missed call log and trigger a push of missed call updates to a wireless device in DND mode. In the disclosed embodiments, the network aware DND system 200 may be integrated with the IMS 140, for example with the TAS 142, or may be an entirely separate component capable of communicating with at least the TAS 142 of the IMS 140. Further, the components of the network aware DND system 200 may be distributed so that one or more components are located within the IMS 140 and/or a separate processing node in communication with or integrated with the IMS 140.

The network aware DND system 200 may be configured for performing the operations described herein utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, subscription logic 240 may be operable to enable a network aware DND system to trigger the TAS 142 to subscribe to the MMTEL profile of the wireless device 130 including the allowed list. Call routing logic 250 may trigger routing functions based on the MMTEL profile and the allowed list. For example, the MMTEL profile may indicate whether the DND feature is activated and the allowed list may include emergency contacts from whom the wireless device user will accept calls even during DND mode. The call routing logic 250 may dictate whether calls are routed to the wireless device or to a voicemail server depending on the MMTEL settings. Further, call logging logic 260 may log missed calls that are diverted during DND mode along with a timestamp and a diversion reason. Finally, call log transmission logic 270 may be operable to trigger transmission of the call logs to wireless device 130 when call logging logic 260 records missed calls. The call log transmission logic 270 may cause the TAS 142 to silently push an update to the wireless device 130. Database 230 may be utilized to store subscription information as well as the maintained call logs. To perform the above-described operations, the subscription logic 240, the call routing logic 250, the call logging logic 260, and the call log transmission logic 270 may be executed by the processor 210 to manage routing of calls during DND mode, the maintenance and transmission of call logs, and further to update the database 230.

Processor 210 may be a microprocessor and may include hardware circuitry and/or embedded codes configured to retrieve and execute software stored in storage device 215. The network aware DND system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the network aware DND system 200 and receive data or information from other system components. User interface 225 may include hardware components, such as touch screens, buttons, displays, speakers, etc. The network aware DND system 200 may further include other components such as a power management unit, a control interface unit, etc.

The location of the network aware DND system 200 may depend upon the network architecture. As set forth above, the network aware DND system 200 may be located in the IMS 140, in a separate processing node, or in multiple locations. Alternatively, the network aware DND system 200 may be an entirely discrete component. Further, although shown as a single integrated system, the functions of the network aware DND system 200 may be separated and may be disposed in separate locations.

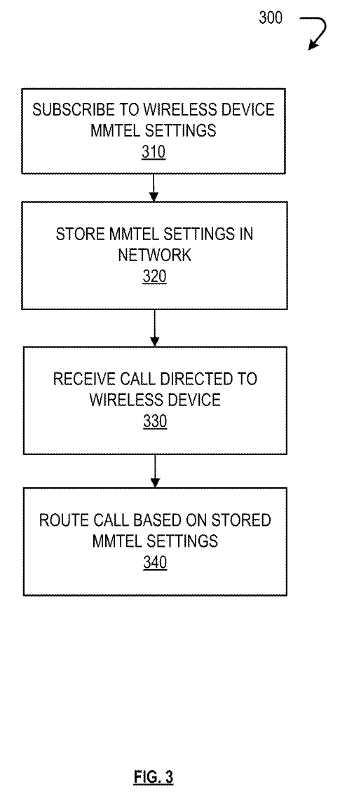

FIG. 3 illustrates a generalized exemplary method 300 for operation of the network aware DND system 200. Method 300 may be performed by a processor, for example, the processor 210 included in the network aware DND system 200, or a processor in the TAS 142. For discussion purposes, as an example, method 300 is described as being performed by the processor 210 of the network aware DND system 200. However, it should be understood that the steps illustrated in FIG. 3 are performed in conjunction with the TAS 142 and the processor 210 may, in fact, be incorporated in the TAS 142.

Method 300 starts in step 310, in which the processor 210 subscribes to the wireless device MMTEL profile settings including the DND allowed list. Through the subscription, the processor 210 can determine whether the wireless device 130 is in DND mode and further, whether callers making incoming calls are on the DND allowed list. As will be further explained below, the network aware DND system 200 may subscribe to the MMTEL profile of the wireless device 130 by communicating with the CSCF 144 and the TAS 142. In embodiments provided herein, the subscription logic 240 is executed by the processor 210 to subscribe the network to the MMTEL profile of the wireless device 130.

In step 320, after the subscription is processed, the processor 210 may store the MMTEL profile in the network. For example, the processor 210 may maintain the subscription and the MMTEL settings in the database 230. Alternatively or additionally, the processor 210 may maintain the subscription and the MMTEL settings at the TAS 142 in a TAS cache or at the HSS 146.

In step 330, the processor 210 may receive calls directed to the wireless device 130. The processor 210 may intercept these calls or may trigger the TAS 142 to recognize the calls directed to a wireless device in DND mode. Finally, in step 340, the processor 210 routes the received call based on the MMTEL settings stored in the network. In some instances, the call will be routed to the wireless device 130 and in other instances, the call will be routed to a voicemail server.

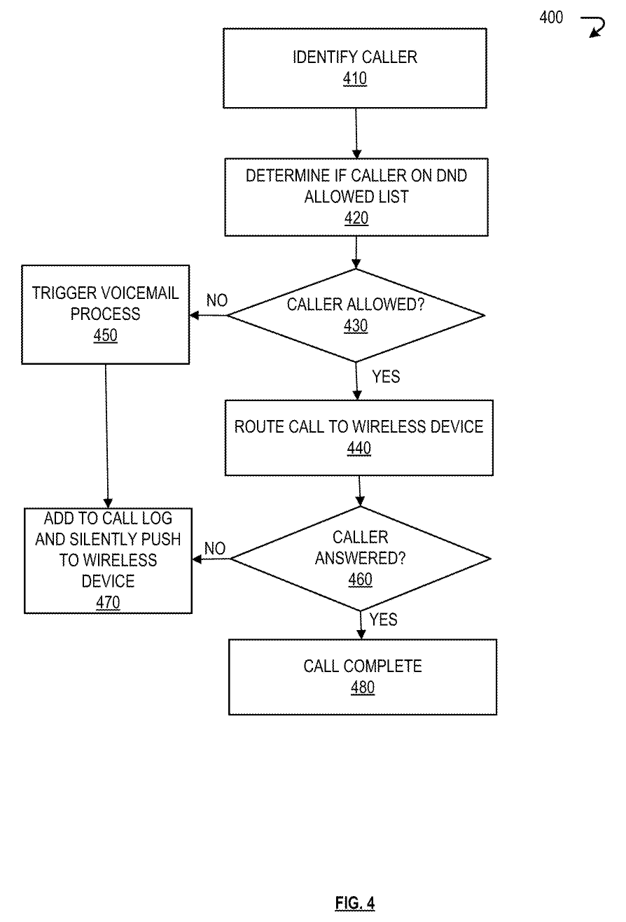

FIG. 4 depicts a further exemplary method 400 for operation of the network aware DND system 200 in accordance with an embodiment. Method 400 may be performed by any suitable processor discussed herein, for example, the processor 210 included in the network aware DND system 200 or in the TAS 142. For discussion purposes, as an example, method 400 is described as being performed by the processor 210 included in the network aware DND system 200, which may be wholly or partially incorporated in the IMS 140 or TAS 142.

Method 400 starts in step 410, and occurs when a wireless device is in DND mode. In step 410, the processor 210 identifies a caller originating a call to the wireless device 130 in DND mode. The caller may be identified, for example, based on a mobile station international subscriber directory number (MSISDN). In step 420, the processor 210 determines if the caller is on the allowed list of the MMTEL profile for the wireless device 130. The allowed list may, for example, include names and an associated MSISDN. By comparing the MSISDN of the received call with stored MSISDNs on the allowed list, the processor 210 is able to determine in step 430 if the caller is in the allowed lists. Further, the processor 210 may utilize other methods in step 420 to determine if the caller is on the DND allowed list.

If the caller is on the allowed list in step 430, the processor 210 may route the call to the wireless device 130 in step 440. In step 460, if the call is answered by the user of the wireless device 130, then the call is completed in step 480. In some instances, even though the caller is on the allowed list and the call is routed to the wireless device in step 440, the wireless device user will not answer the call and the call may be routed to a voicemail server. In this instance, the processor 210 adds the call to a call log with a timestamp and the diversion reason and silently pushes the call log to the wireless device in step 470.

If the caller is not on the allowed list in step 430, the processor 210 triggers the voicemail process in step 450. Additionally, the processor 210 adds the call to a call log with a timestamp and the diversion reason and silently triggers a push of the call log to the wireless device 130 in step 470. processor 210 triggers a call log push to the wireless device 130. The call log push may be triggered from the TAS 142 to the wireless device 130 through SIP messaging. Prior to pushing the call log in step 470, the call log may be maintained in the database 230 or alternatively in the HSS 146. In embodiments disclosed herein, the call log may be deleted from the network storage area after it is pushed to the wireless device 130.

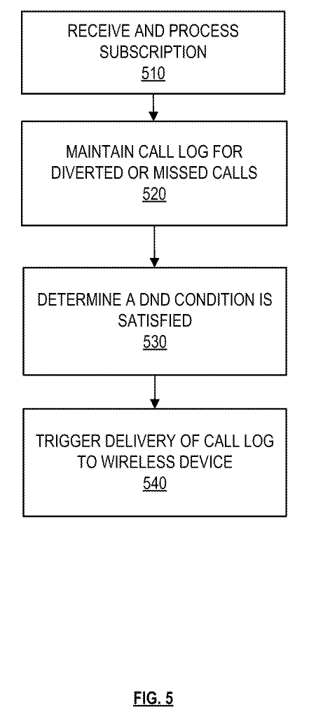

FIG. 5 depicts a further exemplary method 500 for operation of the network aware DND system 200 in accordance with an embodiment. Method 500 may be performed by any suitable processor discussed herein, for example, the processor 210 included in the network aware DND system 200 or in the TAS 142. For discussion purposes, as an example, method 500 is described as being performed by the processor 210 included in the network aware DND system 200, which may be wholly or partially incorporated in the IMS 140 or TAS 142.

Method 500 starts in step 510, and occurs when the processor 210 receives and processes a subscription of a network or TAS 142 to an MMTEL profile of a wireless device. The MMTEL profile indicates whether the wireless device is in DND mode and includes a DND allowed list of callers allowed to contact the wireless device 130 during DND mode.

In step 520, while the wireless device 130 is in DND mode as indicated by the MMTEL settings, the processor 210 maintains a call log for diverted or missed calls. The processor 210 may establish and maintain the call log when calls are diverted from the wireless device 130. In order to maintain the call log, the processor 210 may record call parameters, a timestamp and a diversion reason. The call log may be maintained, for example, in the database 230 or the HSS 146.

Thus, when the call is directed to a voicemail server in the network either because the caller was not on the DND allowed list or because the call was unanswered by the user of the wireless device 130, the processor 210 determines that a DND condition is satisfied in step 530. As a result, the processor 210 triggers delivery of the call log to the wireless device in step 540. For example, the processor 210 may cause the TAS 142 to initiate delivery of the call log to the wireless device 130 through a SIP message. In embodiments disclosed herein, the updates may be a silent push of call log information to the wireless device 130.

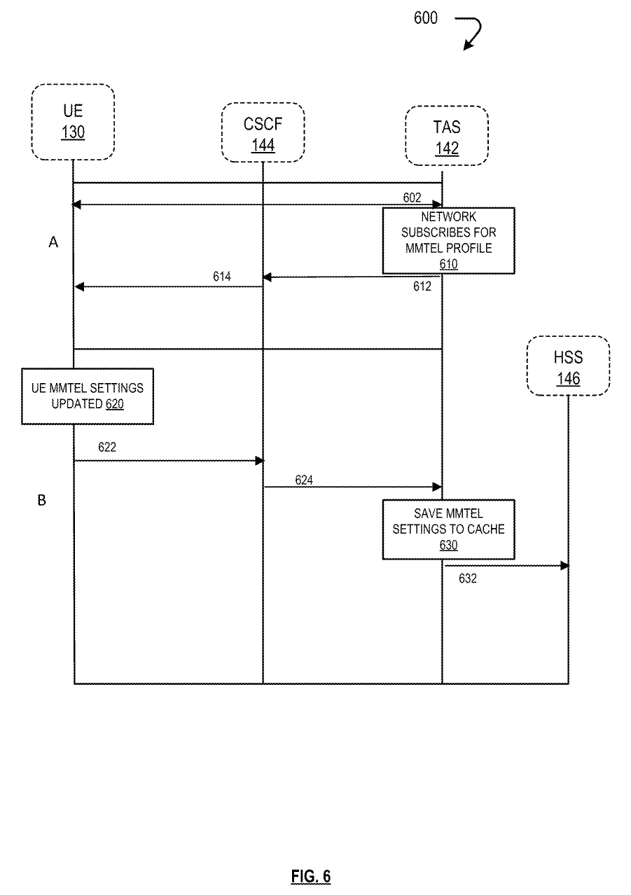

FIG. 6 depicts a flow diagram 600 illustrating interactions between the above-described components during a subscription process A as well as an updating process B for updating MMTEL settings on the network. Interacting components shown include the UE 130, the CSCF 144 and the TAS 142. However, it should be understood that the network aware DND system 200 may either be incorporated in the TAS 142 or in communication with the TAS 142 in order to trigger the various interactions shown in FIG.5. Further, base stations and other network components may be involved in the subscription and updating processes, but are omitted for simplification.

Part A illustrates a subscription process for the TAS 142. In step 602, the wireless device 130 and the TAS 142 engage in an IMS initial registration flow as it currently exists or as it may evolve in the future. In step 610, the TAS 142 subscribes for the MMTEL profile including the DND allowed list. The subscription request from the TAS 142 may be triggered by the network aware DND system 200. In order to subscribe, the TAS 142 sends a subscription request in step 612 to the CSCF 144. The CSCF 144 processes and forwards the subscription request to the wireless device 130 in step 614. In turn, the wireless device 130 receiving the subscription request may process the request using MMTEL profile logic of the wireless device 130. Accordingly, the MMTEL profile logic may send a SIP update to the CSCF 144 with updated MMTEL settings that include the DND allowed list when such settings and/or DND allowed list are updated in the MMTEL profile of the wireless device 130.

Part B illustrates the process of updating the MMTEL settings on the network. In step 620, the wireless device 130 updates its MMTEL settings. Upon making the update, the wireless device 130 sends a SIP update with the updated MMTEL settings and DND allowed list to the CSCF 144 in step 622. In step 624, the CSCF 144 processes and transmits the SIP update with the updated MMTEL settings and DND allowed list to the TAS 142. In step 630, the network aware DND system 200 may trigger the TAS 142 to save the updated DND allowed list and MMTEL settings to a TAS cache. Further, in step 632, the TAS 142 may send the updated DND allowed list and MMTEL settings to be stored at the HSS 146. This step may also be triggered by the network aware DND system 200 and may be achieved through a diameter subscribe notification request (SNR) message.

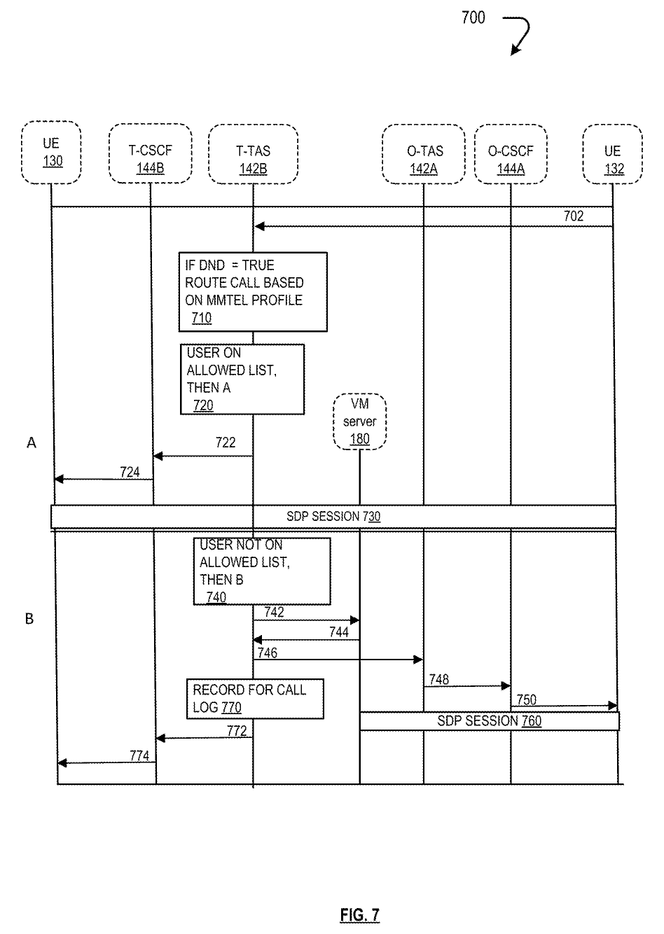

FIG. 7 is a flow diagram 700 that depicts interaction between the above-described components in a scenario in which the wireless device 130 is in DND mode and the network and/or network aware DND system 200 receives a notification of an incoming call to the wireless device 130. More specifically, a wireless device 132 attempts to call the wireless device 130. While a limited number of network components are illustrated, additional or fewer network components may be involved in the interaction.

As illustrated, an originating wireless device 132 sends a SIP request to an originating CSCF (O-CSCF) 144A, which forwards the request through an O-TAS 142A to a terminating TAS (T-TAS) 142B in step 702. In step 710, the T-TAS 142B determines that DND mode is active for the wireless device 130.

Further, in scenario A, in step 720, the T-TAS 142B finds the originating wireless device 132 on the DND allowed list in step 720. Thus, in step 722, the T-TAS 142B allows the call to reach the wireless device 130 by sending a SIP invite to T-CSCF 144B in step 722. The T-CSCF 144B forwards the SIP invite to the wireless device 130 in step 724. As long as the user of the wireless device answers the call, a session description protocol (SDP) session is conducted in step 730.

In scenario B, the T-TAS 142B receives the call notification and determines that the originating caller is not on the DND allowed list. Thus, in step 742, the T-TAS 142B sends a SIP invite to a voicemail server 180 in step 742. The voicemail server 180 responds in step 744 and the T-TAS 142 directs the incoming call to the voicemail server 180 by communicating with the O-TAS 142A at step 746, which prompts the O-CSCF 144A at step 749 and the originating UE 132 at step 750. These steps enable the wireless device 132 to leave a voicemail message for the wireless device 130 in a session description protocol (SDP) session in step 760.

Further, the T-TAS 142B records the call parameters, the diversion reason, and the time stamp to the call history log in step 770. The call log may be stored, for example, at the network aware DND system 200, at a cache of the T-TAS 142 and/or at the HSS 146.

Once the SDP session of step 760 has completed, the T-TAS 142B sends a SIP update including the call history log to the T-CSCF 144B in step 772. The T-CSCF 144B sends the SIP update with the call history log to the wireless device 130 in step 774. Accordingly, the wireless device 130 receives call parameters, a diversion reason, and a timestamp as well as the recorded voicemail.

Although the above-described steps are illustrated as being performed by the T-TAS 142B, the network aware DND system 200 may trigger the steps performed by the T-TAS 142B and further may be incorporated in the T-TAS 142B. Further, the interaction illustrated may be a simplification as additional network components may be involved in the illustrated scenario.

Accordingly, as set forth above, embodiments provide for calls to be directed based on an MMTEL profile and for missed call update logs to be maintained by the network and provided to wireless devices in DND mode. In some embodiments, methods and interactions 300,400, 500, 600, and 700 may include additional steps or operations. Additionally, the various scenarios may include interactions between additional components, which are omitted for ease of explanation. Furthermore, the methods may include steps shown in each of the other methods. Additionally, the order of steps shown is merely exemplary and the steps may be re-ordered as appropriate. As one of ordinary skill in the art would understand, the methods and interactions 300, 400, 500, 600, and 700 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
subscribing, from a network node to user multimedia telephony (MMTEL) settings for a wireless device within a network, the MMTEL settings including a do not disturb (DND) allowed list;
storing the MMTEL settings including the DND allowed list on the network; and
routing calls directed to the wireless device to one of the wireless device and a voicemail server based on the stored MMTEL settings on the network.

2. The method of claim 1, further comprising maintaining a missed call log of calls directed to the voicemail server based on the stored MMTEL settings on the network.

3. The method of claim 2, further comprising silently pushing the missed call log to the wireless device.

4. The method of claim 1, wherein the network node is a telephony application server (TAS).

5. The method of claim 1, further comprising determining the wireless device is in DND mode prior to directing the calls to the wireless device or the voicemail server.

6. The method of claim 5, further comprising identifying a caller and determining the caller is on the DND allowed list prior to directing the call to the wireless device.

7. The method of claim 5, further comprising identifying a caller and determining the caller is not on the DND allowed list prior to directing the call to the voicemail server.

8. The method of claim 1, wherein the MMTEL settings including the DND allowed list are stored in a telephony application server (TAS) cache.

9. The method of claim 1, wherein the MMTEL settings including the DND allowed list are stored on an home subscriber server (HSS).

10. The method of claim 1, further comprising pushing MMTEL setting updates from the wireless device to the network node with a session initiation protocol (SIP) update.

11. A system comprising:
A memory storing data and instructions; and
A processor within a network node executing the stored instructions to perform operations including:
subscribing to user multimedia telephony (MMTEL) settings for a wireless device within a network , the MMTEL settings including a do not disturb (DND) allowed list;
storing the MMTEL settings including the DND allowed list on the network; and
directing calls to the wireless device from the network node to one of the wireless device and a voicemail server based on the stored MMTEL settings on the network.

12. The system of claim 11, the operations further comprising determining the wireless device is in DND mode prior to directing the calls to the wireless device or the voicemail server.

13. The system of claim 11, the operations further comprising identifying a caller and determining the caller is on the DND allowed list prior to directing the call to the wireless device.

14. The system of claim 11, further comprising identifying a caller and determining the caller is not on the DND allowed list prior to directing the call to the voicemail server.

15. The system of claim 11, including a telephony application server (TAS) cache storing the MMTEL settings including the DND allowed list.

16. The system of claim 11, wherein the MMTEL settings including the DND allowed list are stored on an home subscriber server (HSS).

17. The system of claim 11, the operations further comprising receiving MMTEL setting updates from the wireless device with a session initiation protocol (SIP) update.

18. A non-transitory computer-readable medium storing instructions executed by a processor to perform operations comprising:
subscribing to user multimedia telephony (MMTEL) settings for a wireless device within a network , the MMTEL settings including a do not disturb (DND) allowed list;
storing the MMTEL settings including the DND allowed list on the network;
identifying a caller associated with a call to the wireless device;
determining the caller is not on the DND allowed list; and
triggering direction of calls to a voicemail server.

19. The non-transitory computer-readable medium of claim 18, the operations further comprising determining a second caller is on the DND allowed list.

20. The non-transitory computer-readable medium of claim 19, the operations further comprising triggering direction of a call from the second caller to the wireless device.
